(19) United States
(12) Patent Application Publication
(10) Pub. No.: US 2017/0321948 A1
(43) Pub. Date: Nov. 9, 2017

(54) METHOD AND DEVICE FOR AUTOMATICALLY CONTROLLING AT LEAST ONE PARAMETER AT THE CENTRE OF A PRODUCT, AND CORRESPONDING PRE-REFRIGERATION OR REFRIGERATION METHOD AND MACHINE

(71) Applicant: Philippe Christian VITEL, Urmatt (FR)

(72) Inventor: Philippe Christian VITEL, Urmatt (FR)

(21) Appl. No.: 15/515,802

(22) PCT Filed: Sep. 3, 2015
(86) PCT No.: PCT/EP2015/070181

§ 371 Date: Jul. 20, 2017

(30) Foreign Application Priority Data
Sep. 3, 2014 (FR) 1458249

(51) Int. Cl. F25D 11/00; G01K 13/00; F25D 29/00; F25D 31/00

(52) U.S. Cl. CPC F25D 11/003; F25D 31/00; G01K 13/00; F25D 29/003; F25D 2700/06; G01K 2207/04; F25D 2700/16

(57) ABSTRACT

Batches (9a and 9b) pass in succession into a (pre) refrigeration machine. An actuator (17) in the chamber (1) of the machine is controlled by a logic controller (16) to insert a temperature sensor (18) into a product selected in the batch. Above batch (9a) in front of entrance door (6) of chamber (1), a preparatory module (27) explores the top surface of the area at the top of the batch located under sensor (18). An image analyzer selects a product into which sensor (18) will be inserted, and a future insertion point in the selected product. This data is transmitted to a memory to which logic controller (16) will refer to control actuator (17) when the batch is in chamber (1). Preferably, the data refer to a repository linked to the batch, for example provided by a corner of the box (3) containing the selected product.

The present invention relates to a method for automatically controlling at least one parameter, in particular the temperature and/or hygrometry, at the center of a product during a pre-refrigeration or refrigeration process of a batch of such products in a chamber. The present invention also relates to a device for carrying out such a control.

The present invention also relates to a pre-refrigeration or refrigeration method carrying out said automatic parameter control.

The present invention further relates to a pre-refrigeration or refrigeration machine incorporating the parameter control device.

Food products almost always go through at least one pre-refrigeration or refrigeration step as they follow their path between the place of harvest, fishing, slaughter or other collection point, and the place of destination such as a retail store. The first refrigeration after collection is called “pre-refrigeration” and “refrigeration” is referred to as a subsequent refrigeration, for example after treatment and packaging of the product.

Many products require precautions during their pre-refrigeration or refrigeration. In particular, products must be brought to a quite precise temperature, low enough for their proper preservation, but not too low to avoid damaging them. The optimal temperature varies depending on the product. Furthermore, depending on their nature, the temperature decrease of the products and the homogenization of the temperature inside the product are more or less quick. Pre-refrigeration or refrigeration is often carried out by batches in large size chambers. These are, for example, batches composed of several pallets loaded with products up to typically 2.60 meters in height and which are introduced into a (pre-) refrigeration tunnel. The batches may also consist of trolleys, sometimes shelf trolleys, or overhead conveyors, for example for chickens, or others.

Patent FR 2 977 013 B describes a (pre-) refrigeration method wherein the batch is subjected to both a low pressure in the chamber and the action of a cooling coil, which refrigerates the atmosphere of the chamber. The low pressure is such that the water initially present, exuded or added to the surface of the products, starts to boil. It is known indeed that the boiling temperature decreases when the pressure decreases. By greatly reducing the pressure within the chamber, the boiling temperature of the water can be as low as a few degrees Celsius. This boiling, which consumes a lot of calories, constitutes a source of cold, which is very effective because perfectly coupled thermally with the products. The boiling produces water steam, which is condensed and optionally frozen by the cooling coil, which additionally provides adjustable additional refrigeration power, which acts on the products by convection.

This prior patent proposes to monitor the (pre-) refrigeration process by means of a temperature sensor, which is manually stuck into a control product selected from those of the batch, so that the sensitive tip of the sensor is located at the center of the control product. When the desired temperature is reached at the center of the control product, the (pre-) refrigeration process is automatically stopped and the batch is taken out of the chamber.

This temperature control method works well but has some implementation drawbacks. It is not easy to place the sensor in a product that is part of a bulky batch, for example in a product located on top of a batch of 2.60 meters in height. There is a risk of accident. The operation takes time. Insertion of the sensor into the product may be incorrect. This results in incorrect control of the entire (pre-) refrigeration process. At the end of the (pre-) refrigeration process, the load must be climbed again to take the sensor out, which causes new delays and risks of accidents. In case it is forgotten, the sensor is pulled off when the batch is removed (departure of the pallet carrying the batch) and considerable damage is possible.

It has also been found according to the present invention that temperature is not the only parameter whose control may be desirable. In the case of refrigeration by low pressure, for example according to FR 2977013 B, wherein water is evaporated on the surface of the products, it is particularly advantageous to control the hygrometry at the center of the products. If the products tend to become excessively dry, it is possible in particular to activate watering means provided in the chamber, or also to reduce the low pressure (letting the absolute pressure increase within the chamber) and possibly to increase the power of the cooling coil.

The aim of the present invention is to improve the automation of the control of the parameter such as temperature, hygrometry, etc., so as to address at least in part the drawbacks of the state of the art discussed above.

According to the invention, the method for automatically controlling at least one parameter at the center of a control product that is part of a batch during a pre-refrigeration or refrigeration process of the batch in a chamber, characterized in that, in order to stick the sensor, while the batch is already inside the chamber, an activator is activated which carry and move the sensor inside the chamber, and in that after the pre-refrigeration or refrigeration process the activator takes the sensor out of the control product.

Thus, human manipulations for insertion and extraction of the sensor are at least for the most part, if not totally, removed. Additionally, the insertion and extraction take place inside the chamber, preferably mainly in hidden time during closing and opening of the doors respectively. In a preferred embodiment, the activator is controlled by an automaton in such a way that the sensor performs defined movements.

In a preferred version, a product of the batch is selected as control product so that in the chamber said control product is as near as possible from a standby position of the sensor. This judicious selection shortens the implementation time, limits the risk of malfunctioning and simplifies the necessary equipment by minimizing the maximum working stroke to be provided for the activator.

Preferably, the control product is identified before the entry into the chamber. This way, the equipment to be provided in the chamber, wherein available space is limited, is reduced to the strict minimum required and the ambient conditions (thermal, hygrometric, barometric variations, electromagnetic fields etc.) are relatively strict. In addition, the identification part of the method is operated in hidden time on a standby batch while a previous batch is being cooled in the chamber.

In one version of the method, the identification consists in associating a beacon with the control product, and there is in the chamber a contact or contactless position detector for detecting the beacon. The beacon may be, for example, a kind of small individual basket for the control product. In the chamber, the detector identifies the basket and the automaton guides the sensor so that the sticking is performed at the center of the basket.

The position detector may be optical, which make it possible to detect the position of the beacon as indicative of the position of the control product in the chamber, after which the automaton guides the sensor towards the control product.

Typically the beacon is put in place before the batch enters the chamber. However, it may not be necessary to retrieve the beacon when the batch leaves the chamber: the beacon may for example be a low value object, for example made of cardboard or plastic material, which does not need to be recovered.

The beacon position detector may alternatively comprise a mechanical feeler which provides a position signal for the beacon or which is shaped to be mechanically wedged to the beacon and at the same time to guide the sensor to a position centered on the control product. For example, the beacon may have the shape of a flared cup holding the control product. During a downward movement of the sensor by the activator, the vertical tube-shaped feeler coaxial with the sensor centers itself in the cup. For this purpose the feeler and the sensor have a lateral movement freedom. When the feeler is centered in the cup, the activator pushes the sensor into the control product. In this version, the lateral movement of the sensor is produced only indirectly by the activator: it is the downward movement that is converted by the contact between the beacon and the feeler to have a lateral element, the beacon forming a cam for the feeler.

In a preferred version of the method, the identification consists in detecting the position of the control product and/or of a sticking point on the surface of the control product, and transmitting to a memory connected to the automaton a signal indicative of said position.

Even more preferably, said position is detected by analyzing an image of at least one part of the batch, and selecting as control product a product appearing on the image. The analysis may, for example, consist in finding a highest point of a selected product in an area of the batch, and selecting this highest point as the future sticking point of the sensor. The highest point of the product as arranged in the batch, typically on top of the batch, corresponds to a point that will minimize the axial movement of the sensor. In addition, the surface of the highest point product is likely to be substantially horizontal, thus favorable to vertical sticking. Moreover, if the sensor is stuck at the highest point, chances that a sticking stroke of given length will bring the sensitive tip of the sensor to the center of the control product are optimized. Preferably the method analyzes a 3D image of an area of the batch, typically an area at the top of the batch. Image analysis includes the search for a product highest point as the future sticking point of the sensor. The “highest point of a product” is the highest above the soil product point, the product being considered as it is arranged in the batch. In the analyzed zone, it is possible to choose the product highest point that will be the closest to the axis of the sensor in standby position, the product having this highest point therefore being the control product within the meaning of the invention.

In a version of the method, at least one part of the outline of a crate containing some of the products of the batch is detected and the at least one part of the outline of the crate is used as a reference frame, the control product being chosen from within said outline. It is for example possible to locate the four corners of the crate, or a corner of the crate and the two sides forming this corner.

Preferably, the at least one part of the outline of the crate surrounding the sensor standby position axis is detected when the batch is in the chamber. Then, preferably, the image inside the outline of the crate which has been the subject of the outline detection is analyzed in order to select, as a selected product, the one which in the chamber will be crossed by the axis of the sensor in standby position, or the one in the chamber whose highest point will be the closest to the sensor in standby position. According to an advantageous development, the signal indicates the position of the product or of the sticking point with respect to a reference frame connected to the batch, and there are in the chamber means able to locate the reference frame in order to allow the automaton to control the activator with respect to this reference frame.

Typically, the position of the outline of the crate containing the control product constitutes an advantageous reference frame. In the chamber, the position of the outline of the body is detected, which then allows the sensor to be positioned precisely so that its axis passes through the intended sticking point in the control product. The use of a reference frame that moves with the batch makes it possible to stick the sensor at a precise point of the control product even if the position of the batch is not precisely known with respect to the identification unit and/or in the chamber.

Even if a reference frame connected to the batch is used as mentioned above, it is advantageous to ensure that the position of the batch with respect to the identification unit and/or in the chamber is relatively well determined, for example by a few centimeters. For this purpose, at least one retractable stop can be provided, for selectively cooperating with the batch, for example with a pallet bearing the batch. For example, at least one stop is set in an active position upstream from the entry into the chamber in order to immobilize the batch at a determined position during identification. Alternatively or additionally, at least one other such stop may be set in active position in the chamber in order to immobilize the batch in a determined position during sticking.

In a preferred embodiment of the method, the activator causes the sensor to move at least partially laterally before sticking so as to center the sensor on the sticking point and then to perform a substantially axial sticking movement.

The sticking movement covers a stroke equal to the sum of the distance remaining between the tip of the sensor and the product and the sticking stroke of the sensor into the product. The sticking stroke data is available to the automaton, adjustable by the user or the manufacturer of the machine according to the product to be treated. For example, there may be several stroke values in memory for several types of products that can be treated.

Preferably, in the chamber, during the sticking of the sensor into the control product, and while the sensor is taken out at the end of the pre-refrigeration or refrigeration process, a blocker is applied to the product which immobilizes the control product during sticking and extraction. The sensor sticking process is thus secured by, for example, preventing the product from rolling under the pressure applied by the sensor at the very beginning of the sticking. In process versions that use a mechanical feeler to be self-positioned relatively to a beacon, the feeler can act as a blocker after the self-positioning process.

In one embodiment, prior to sticking the sensor into the control product, an outer wall of the control product is pierced at the future sticking point by a tool controlled in a coordinated manner with the sensor. This is advantageous for products having a tough skin.

In a simple version, the control product is a product located in the chamber opposite a standby position of the sensor. The sensor may, for example, be systematically in standby position facing the inside of a crate. When treating products of small size and/or of small thickness and/or forming a mass with one another, it is then sufficient to move the sensor to stick into the mass without aiming at a specific sticking point of an individual product. The control product is then the content of the crate, or more generally the products that are within range of the sensor.

In a concrete embodiment, a process capable of selectively operating by targeting a product or a selected sticking point or by axially sticking into the product mass depending on the type of products treated is preferred. Preferably, the sensor is automatically cleaned periodically between two batches.

According to a second aspect of the invention, the method of pre-refrigeration or refrigeration of products by the cold-vacuum technique in a chamber, wherein the inside of the chamber containing the products is subjected to the combined effect of a vacuum for which the water boils at substantially the desired refrigeration temperature for the product and a cold produced by a refrigeration machine which cools the atmosphere inside the chamber and turns into ice the water vapor resulting from the boiling, is characterized in that by means of a method according to the first aspect, a parameter at the center of a control product being part of said products is automatically controlled and according to the value of said parameter at the center of said control product the pre-refrigeration or refrigeration process is automatically controlled, in particular the process interruption. Typically, the at least one selected parameter comprises temperature, and/or hygrometry.

The cold-vacuum (pre-) refrigeration technique is for unpackaged fresh products or products packaged in a non-tight manner, or more generally products which are in contact with the outside so as to be able to exude the water escaping in the form of water vapor. All these products can therefore be stuck by the sensor without being damaging or altering their cooling process in such a way that their thermal evolution or other parameter evolution at their center would no longer be representative of the batch.

According to a third aspect of the invention, the automatic device for controlling at least one parameter at the center of a control product that is part of a batch, during a pre-refrigeration or refrigeration process of the batch in a chamber, comprising a temperature sensor intended to be stuck into the control product so that a sensitive end of the sensor is at the center of the product, is characterized in that it further comprises an activator located in the chamber and carrying the sensor in a movable manner, and means for controlling the activator so that the sensor performs a sticking movement in the control product at the beginning of the (pre-)refrigeration or refrigeration process and an extraction movement out of the control product at the end of said process.

Preferably, the device comprises an identification unit for providing an identification of a product of the batch, selected as said control product intended to receive the sensor, and in that the controller comprises an automaton for controlling the activator according to the identification firstly by an at least partially lateral centering movement of the sensor on a sticking point and then by a sticking movement of the sensor in the control product. Advantageously, the control product is on top of the batch, and the axial movement is essentially directed vertically downward.

In an advantageous embodiment, the identification is indicative of a sticking point of the sensor through the surface of the control product. The sticking point is preferably a highest point of the control product as arranged in the batch.

Preferably, the device comprises means for detecting a product as said control product and for producing as said identification a signal indicative of the coordinates of the sticking point on the surface of the control product, and in that the automaton receives said signal as an input via a memory. The identification unit is preferably placed at a station through which the batch passes upstream of the chamber. In this case, the device typically comprises two units, namely a unit upstream of the chamber, with the identification unit, and a unit in the chamber, with the sensor and the activator.

In a preferred embodiment, the identification unit comprises an image sensor and an image analyzer. The image sensor may be a camera that provides a 2D image or preferably a scanner type laser, which provides a 3D image with the spatial coordinates of each point of the image. As explained above, this 3D image can be processed in order to extract the highest point of each product displayed.

The identification unit advantageously searches in the image, as a future control product, a product that will minimize the lateral centering movement of the sensor from a standby position of the sensor. In the case of the search for a highest point, it can then be more particularly searched the one that will be, in the chamber, the closest to the axis of the sensor in standby position, at least among the products situated on top. In the case of a 2D image, the image analyzer recognizes for example an outline of the products and selects an outline as that of the future control product. The selected outline is, for example, the one that is complete (product located on the top) and which in the chamber will surround the sensor axis in the standby position or will be the least distant thereof. The device may comprise, in memory, topographic data relating to at least two different types of products. On manual or automatic setting, the device takes into account the topographic data relating to the product being treated, for example in terms of outline shape, depth of insertion of the sensor in the product, optimal sticking force for each type of product, optimal sticking point for certain product types, etc.

When the device comprises a receiver for receiving as an input some information on the type of product forming the batch, it is advantageous for the device to check whether the read image matches the topographical data relating to said information. Errors in refrigeration treatment applied to a batch can thus be avoided.

The device comprises means allowing to provide the identification with respect to a reference frame connected to the batch, so that in the chamber the automaton can control the sensor by referring to the same reference frame, whatever the uncertainties on the movement of the batch between the station where the identification took place and the position of the batch in the chamber. In a very advantageous embodiment, the image analyzer identifies at least a part of the outline of a crate containing the control product, and performs the identification of the control product with reference to the outline of the case.

In this case, inside the chamber, the device preferably comprises a detector for detecting the said part of the outline of the crate containing the control product, and the device locates the control product and, where appropriate, the sticking point in the chamber with respect to the detected outline.

The outline of a crate is easy to detect automatically, both during the identification and subsequently in the chamber for the control of the sensor until the sticking point. In addition, since the uncertainties regarding the positioning of the batch in the chamber are small compared to the size of a crate, giving the position of the control product or the sticking point inside the outline of the crate containing this product is sufficient for the robot to safely guide the sensor towards the control product or the sticking point respectively, without any risk of error on the crate whose outline serves as a reference frame. In the chamber, an optical or mechanical detector detects the outline of the crate surrounding the axis of the sensor in standby position, and then the automaton controls the sensor relatively to this reference frame. There is therefore no need for the identification unit to transmit coordinates of the outline of the crate.

A memory can be provided containing the outlines of all common crate models, most often cardboard or plastic crates. This makes easier the detection of the outline of the crate containing the product to be selected. At the beginning of a series of batches containing products of the same kind in crates of the same type the user sets as an input of the device the type of crate used. Alternatively, the device includes a system for recognizing the type of crate used amongst those in its memory. In an embodiment that does not require optical reading or image sensors or an image analyzer outside the chamber, the identification unit is a beacon associated with the control product, and the device comprises a detector located in the chamber for detecting the position of the beacon. The beacon can be a very simple object such as a small basket containing the control product selected by the operator.

The detector may comprise a feeler. The feeler can be designed in order to self-position on the beacon. In this case, the sensor is advantageously coupled to the feeler to move laterally with the feeler. Thus the detection of the product is simultaneous with the first step, called the “centering step” of the sensor.

Advantageously, the device comprises a product blocker for immobilizing the control product during the sticking and during an extraction of the sensor by the activator following the pre-refrigeration or refrigeration process. The blocker stabilizes the product during sticking and prevents the product from following the sensor during the extraction movement of the sensor after the (pre-) refrigeration process. In the case considered above where the device comprises a feeler for a beacon, this feeler may at the same time constitute the aforementioned blocker.

In one embodiment, the blocker remains in place on the control product during the temperature measurement. The product blocker may be slightly moved away during the (pre-) refrigeration process so that the thermal and mechanical contact of the control product with the blocker does not alter the thermal behavior of the control product during the process.

The blocker has, for example, an active ring-shaped end, which surrounds the sensor.

Advantageously, the blocker is connected to the sensor with an axial sliding freedom beyond a stress threshold corresponding to the immobilization stress applied to the control product. Typically, the activator moves the sensor while an elastic compressor pushes the blocker into a protruding position with respect to the sensor, position defined by a stop. The tip of the sensor is then slightly backward compared to the blocker. Therefore, the blocker is the first to come into contact with the control product. At the latest at this moment the movement of the sensor becomes strictly axial while the blocker stops and the elastic compressor is compressed, generating the calibrated stress of application of the blocker on the product.

Preferably, the depth of penetration of the sensor into the control product, depending on the nature of the products of the batch, is configured on the device.

In an advantageous embodiment, the device comprises a piercer for piercing an outer wall of the control product at the future sticking point, prior to sticking the sensor into the control product, and/or a cleaning device for periodically cleaning the sensor between two batches. The sensor is typically a temperature sensor or a hygrometry sensor. If necessary, two parallel sensors can be used, or one sensor carrying two feelers at its sensitive end can be used. According to a fourth aspect of the invention, the pre-refrigeration or refrigeration machine is equipped with a device according to the third aspect.

Preferably, it is a machine working with a cold-vacuum couple in the chamber.

Other features and advantages of the invention will still emerge from the description below, relating to non-limiting examples. In the accompanying drawings:

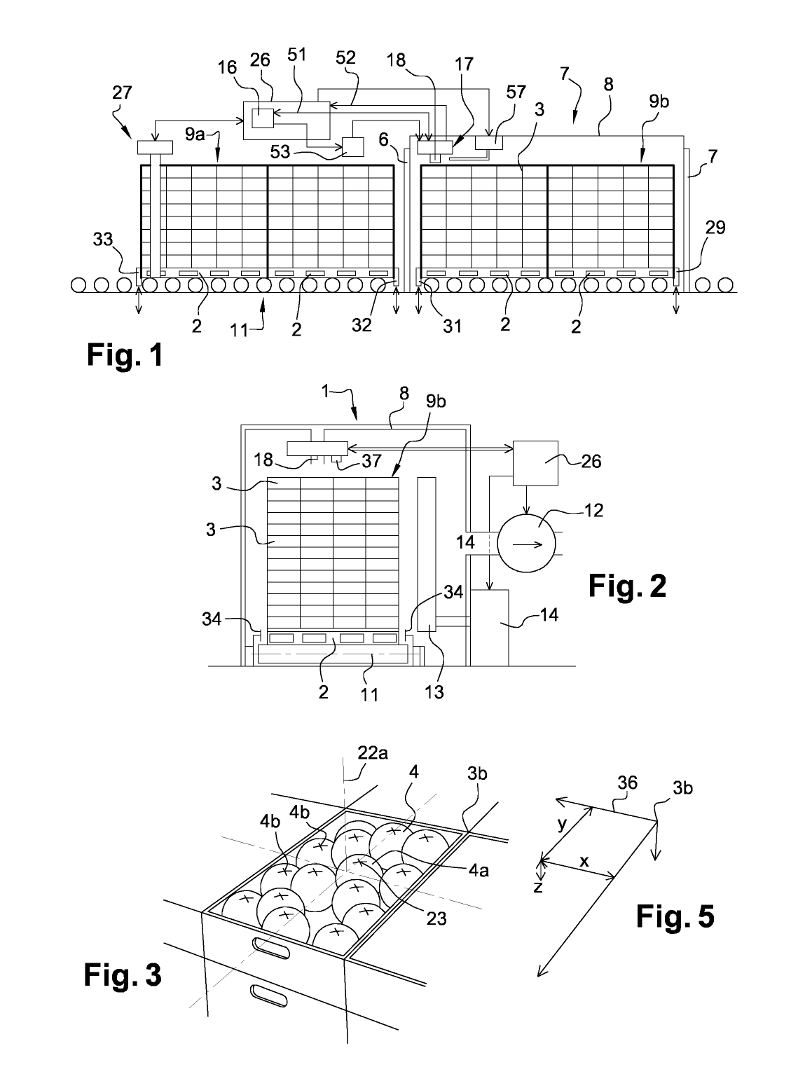

FIG. 1 is a schematic side elevation view of a (pre) refrigeration installation according to the invention;

FIG. 2 is a schematic cross-sectional view of the (pre-) refrigeration tunnel of the installation of FIG. 1;

FIG. 3 is a perspective view of a crate located on the top of a batch before it enters the tunnel;

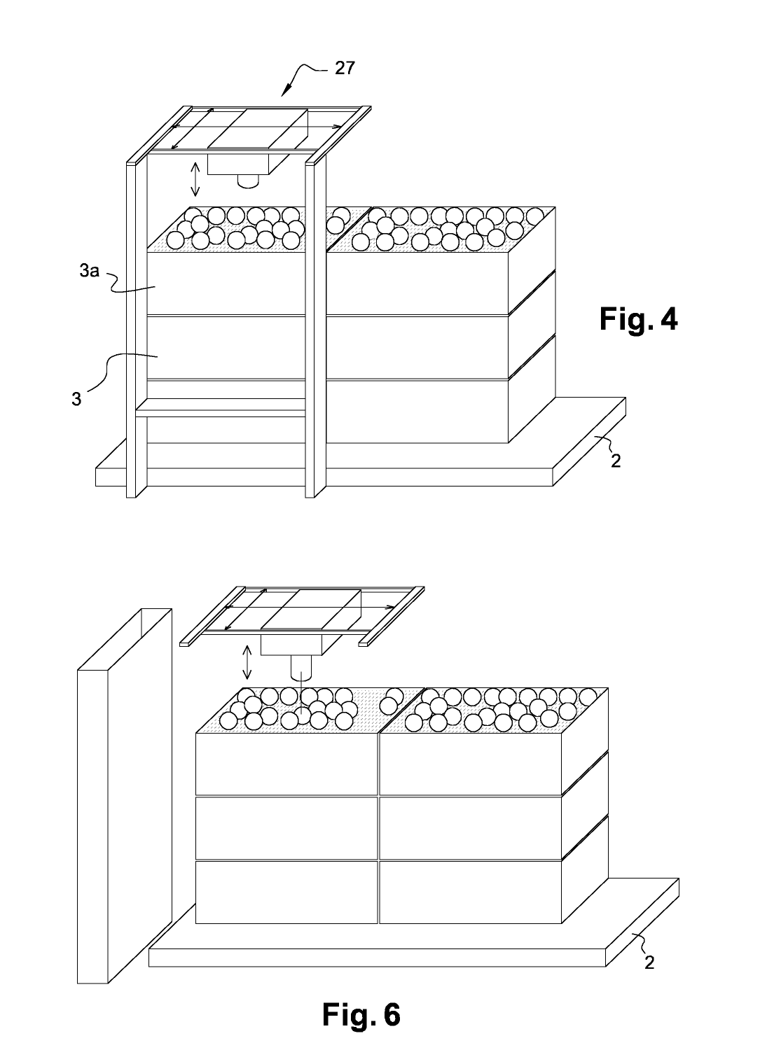

FIG. 4 is a schematic perspective view showing the identification step in a first embodiment of the method;

FIG. 5 is a diagram showing the identification of the sticking point;

FIG. 6 is a schematic perspective view illustrating the sticking step in the first embodiment of the method;

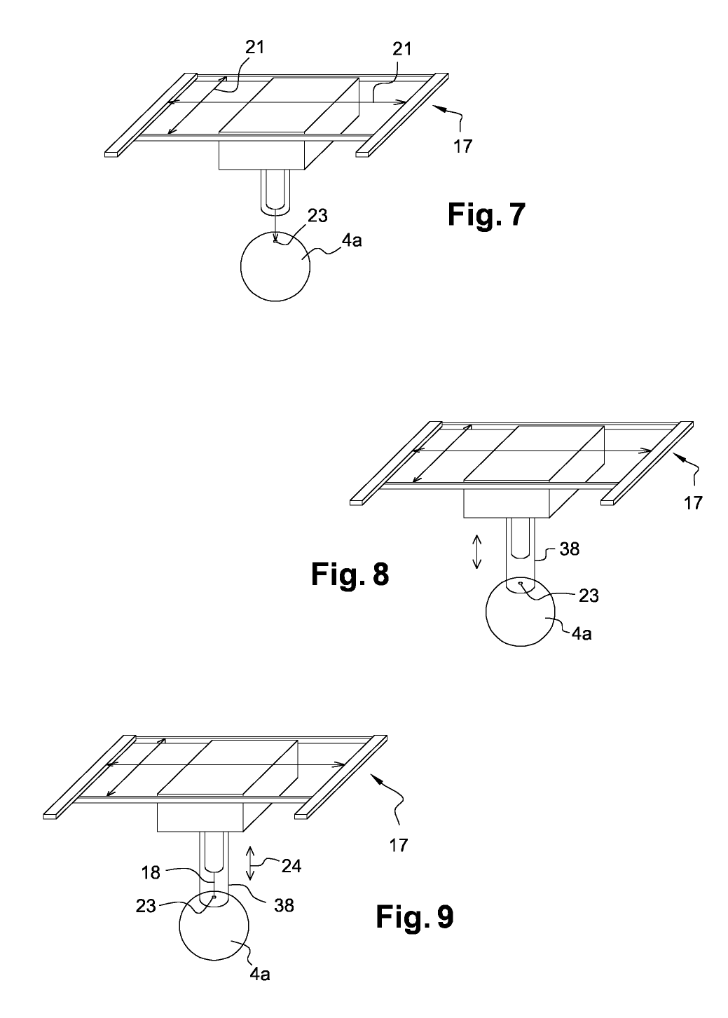

FIG. 7 is a schematic perspective view showing the centering movement of the sensor;

FIG. 8 is a schematic perspective view showing the immobilization of the selected product step;

FIG. 9 is a schematic perspective view illustrating the sticking of the sensor into the selected product;

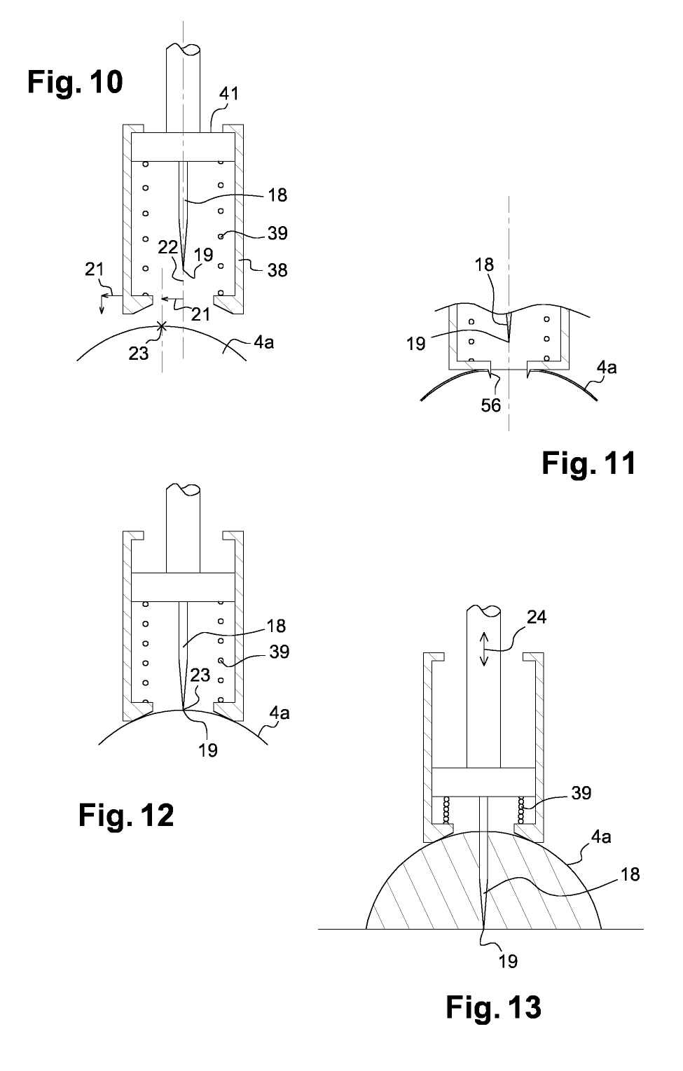

FIG. 10 is an axial section schematic view of one embodiment of the sensor and of the blocker in waiting position;

FIG. 11 shows a partial view of the beginning of the blocking, with at the same time a representation of another embodiment of the blocker incorporating a piercing tool;

FIG. 12 shows the sensor of FIG. 10 ready to be stuck into the selected product;

FIG. 13 shows the sensor and the blocker of FIG. 10 when the sensor is stuck into the product;

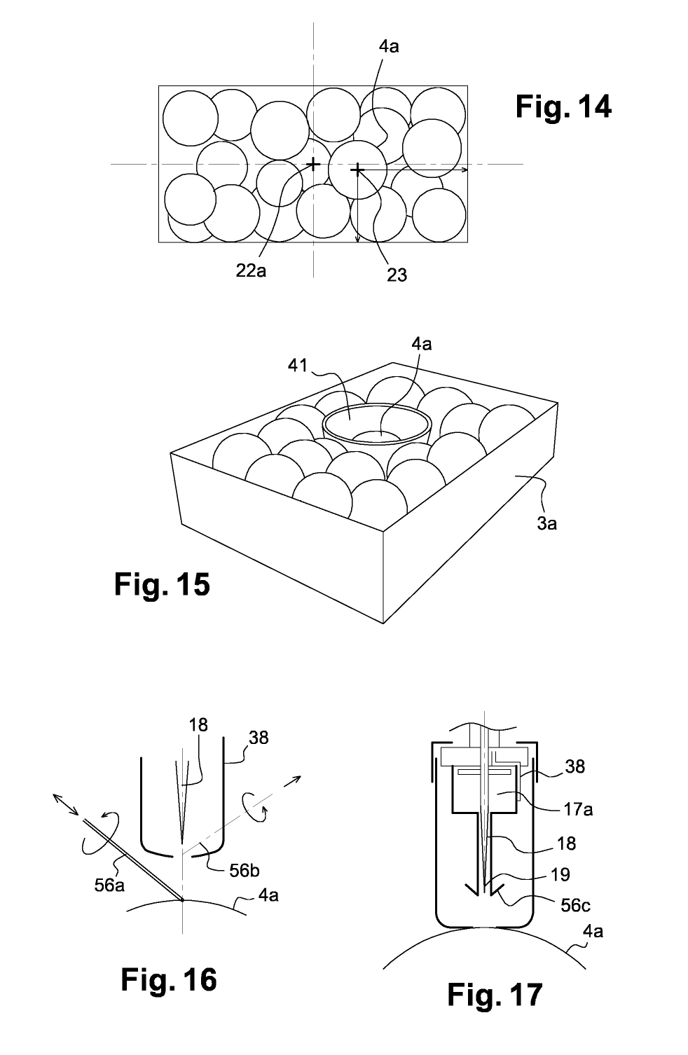

FIG. 14 is a view of a 2D image of a crate according to a second embodiment of the method;

FIG. 15 is a perspective view of a beacon placed in a crate containing refrigerated products, in a third embodiment of the method; and

FIGS. 16 and 17 are axial section diagrams of two other embodiments of the piercing tool.

The description that follows is to be considered as an individual description of each mentioned feature, in the form as described or in any more or less generalized form, independently of the other features even mentioned in the same paragraph or the same sentence, or as a description of any partial combination, as described or more or less generalized, independently of the other features of the combination even mentioned in the same paragraph or the same sentence, provided that such an individual feature, possibly generalized, or such a partial combination, possibly generalized, is capable of distinguishing the invention from the prior art or providing a technical result or solving a technical problem with respect to the prior art.

Hereinafter, the term “refrigeration” is used to refer to refrigeration as well as pre-refrigeration, the following description applying equally to these two cases. In the example shown in FIG. 1, the refrigeration installation comprises a refrigeration chamber 1 designed to receive and cool in a controlled manner successive batches 9a, 9b of products. In the purely illustrative example, each batch is composed of two pallets 2 on which are stacked crates 3, each crate 3 containing fresh products which in this example are fruits 4 of generally spherical shape (FIG. 3). The invention also applies to other forms of edible or non-edible plants (eg flowers), non-tightly packaged products, seafood or meat, fresh or packaged in a non-tight manner, etc. The chamber comprises in this example a tunnel 8 comprising, at two opposite ends, an entrance door 6 and an exit door 7, respectively, for the batch. FIG. 1 shows a batch 9a located outside the chamber 1 in a standby position in front of the entrance door 6, and another batch 9b located in the chamber 1. There could also be a third batch, not shown, located outside the chamber 1 behind the exit door 7, composed of products already refrigerated and waiting to be loaded onto a vehicle (lorry, boat, etc.) or carried locally to a next step of the process, for example a freezing or preservation step in a traditional cold room. There could also be a cold or freezing or deep-freezing chamber directly at the exit of the tunnel, behind the exit door 7.

In the example shown, the pallets 2 supporting the batches 9a, 9b rest on a roller track 11 allowing the batches to move along the longitudinal axis of the tunnel 8, from the waiting station upstream of the tunnel (left on FIG. 1), then in tunnel 8, until the starting station downstream of the tunnel (to the right of the exit gate 7 in FIG. 1). Means (not shown) make it possible to move the batches along the roller track 11.

In a preferred embodiment, the chamber 1 is part of a refrigeration machine (FIG. 2) working by combined application of vacuum and cold to the products to be refrigerated. The vacuum is applied by a vacuum pump 12. The cold is applied by a cooling coil 13 made up of the evaporator of a refrigeration machine 14. Thanks to the vacuum pump 12, the absolute pressure in the chamber 1 is decreased to a sufficiently low value (for example around 2 kPa) for the boiling temperature of the water to correspond to the target temperature for the products, for example a few degrees Celsius. Thus, the water naturally present or added to the surface of the products 4 starts to boil. This boiling very effectively cools the products. The intake opening 14 of the vacuum pump 12 is located behind the cooling coil 13 so that the gaseous atmosphere sucked in by the pump 12 comes into contact with the cooling coil 13. The water vapor resulting from the boiling condenses or turns into ice in contact with the cooling coil 13. This reduces significantly the volume of gas to be treated by the pump 12 and therefore the energy consumed by the pump 12.

Preferably, the machine is in accordance with FR 2 977 013 B, to which reference will be made for more details. According to the invention, the machine comprises an automaton 16, which controls the activator 17 located in the chamber 1. The activator 17 carries a sensor 18 for detecting at least one parameter, typically the temperature and/or the hygrometry. The sensor is intended to be stuck in a control product 4a, selected from the products 4 of the batch, so that the sensitive end 19 (FIGS. 10 to 13) of the sensor is located at the center of the product 4a, as shown in FIG. 13.

The activator is connected to the automaton via a bidirectional link 51. The sensor is connected to an electronic cabinet 26, which here contains the automaton, via a link 52. The activator is preferably pneumatic and is connected to a pneumatic energy generator 53, itself controlled by the automaton 16.

In the context of the invention, the automaton 16 may be a hardware-based automaton, for example comprising electronic cards, or a software or a part of a software in the control cabinet, or it may be more generally integrated into the control cabinet in the form of certain functions provided by the control cabinet, among others, such as operating the doors, controlling the vacuum and cold machine, controlling the displacement of the batches (not shown).

In the preferred example shown, the activator 17 as well as the sensor 18 are located beneath the ceiling of the tunnel 8, above the area occupied by the batch 9b, preferably near the entrance door 6 and/or in a position far away from the cooling coil and the appliances such as engines that generate electromagnetic waves. The sensor 18 is in a downward position in order to be stuck in a control product 4a located on the top of the batch 9b. The activator 17 is able to move the sensor 18 along both lateral axes, here horizontal, as well as axially, that is to say here vertically. As shown in FIGS. 7 and 10, the lateral movement 21 is used to cause the axis 22 of the sensor to pass through a sticking point 23 in the control product 4a. The axial movement 24 (FIGS. 9 and 13) is particularly used to push the sensor 18 into the control product 4a prior to the refrigeration process, and to extract the sensor 18 from the control product 4a after the refrigeration process and before the departure of the batch 9b through the exit door 7 of the chamber 1. During the refrigeration process, the sensor measures the temperature decrease profile at the center of the control product 4a and sends a temperature signal to the control cabinet 26 of the machine. When the control cabinet detects that the target temperature has been reached, it commands the stop of the refrigeration process and starts the automaton 16 for an end-of-process sequence comprising the extraction of the sensor from the control product 4a and a lateral movement of the sensor to return to a predetermined standby position.

In an improved embodiment, the control cabinet 26 adjusts the vacuum and cold parameters in real time during the refrigeration process, taking into account in particular the temperature decrease profile detected by the sensor 18 and, if necessary, the hygrometric behavior of the control product during the refrigeration process.

A cleaning device 57, preferably operated by spraying, cleans the sensor between two batches under the control of the electronic cabinet 26.

In the preferred embodiment shown, the parameter control device comprises, in addition to the unit located in the chamber 1, including in particular the sensor 18 and its activator 17, a preparatory or identification unit 27, which cooperates with the Batch 9a waiting in front of the entrance door 6 to identify the product 4a selected to be the control product, and to locate the sticking point 23 (FIG. 3) selected for this batch and to send this identification to a memory provided in the automaton 16 or in connection therewith. When the batch that has been the subject of this identification is located in the chamber 1, the automaton 16 uses the identification data contained in the memory to control the activator 17 and thus the sensor 18 into the state shown in FIGS. 9 and 13, where the sensitive end 19 of the sensor 18 is located at the center of the control product 4a.

The preparatory unit 27 comprises, in the preferred example, a 3D image sensor (FIG. 4) operating by scanning in both horizontal directions above a selected crate 3a, which is the one that will be located under the sensor 18 in standby position when the batch will be in the chamber 1. (For the purpose of readability of FIGS. 4 and 5, very simplified, the crates have been drawn to be relatively very large and very small in number on a single pallet 2 symbolizing the batch). The 3D image sensor 27 digitizes an image of the upper surface of the batch 9a in an area including the crate 3a. It is associated with an image analyzer, which determines the position of at least a part of the outline of the crate 3a as well as the highest points 4b of the products 4 located on the top, for example the highest points 4b that are located less than a predetermined distance from beneath the upper edge of the crate 3a (FIG. 3). The image analyzer selects as the sticking point 23 the highest point that is the closest to the vertical axis 22a, which will probably match with the axis 22 of the sensor when the batch will be in the chamber 1. The axis 22a must therefore be considered as connected to the batch. The matching of the axes 22a and 22 will not be exact because the movement of the batch is only accurate to a few centimeters.

The product 4a selected to be the future control product is in this preferred example the one whose highest point has been chosen as the future sticking point 23. In order to improve the matching between the position of the selected crate 3a under the image sensor 27 and the position of the same crate 3a under the sensor 18, retractable stops 29, 31, 32, 33 (FIG. 1) define the position of the batch 9a in standby position and the batch 9b in the chamber 1 respectively. The front stops 29 and 32 retract for the movement of the batches and then return to their protruding position before the arrival of the next batch to stop the batch at the determined position. The rear stops 31 and 33 rise after the batch stops in order to lock the positioning. The lateral positioning of the batches is ensured by lateral slides 34 (FIG. 2).

As shown in FIG. 5, the image analyzer preferably sends to the memory of the automaton 16 not an absolute position of the sticking point 23 but a relative position in x, y and z with respect to a reference frame corresponding to an upper angle 3b of the crate 3a.

Once the batch is in the chamber 1, the crate 3a, which has been selected for this purpose, is directly below the sensor sticking unit and the position of the angle 3b of the crate 3a is predictable by a few centimeters. A small 3D image sensor 37 (FIG. 2), covering for example only the area where the angle 3b can be, locates this angle and the orientations of the crate edges that form the angle, which determines the position of the reference frame 36 in the chamber 1 for this batch. The standby position of the sensor 18 is determined by the automaton in the reference frame 36. The automaton calculates the movement of the sensor tip along the three axes, to go from its standby position to the provided sticking point 23 and controls the movement of the sensor 18. Then the automaton controls an axial movement of the sensor so that the sharp tip of the sensor perforates the selected product 4a at the intended sticking point 23 and pushes this tip over a predetermined stroke so that the sensitive tip 19 of the sensor reaches the center of the product 4a.

In the preferred example shown the sticking unit located in the chamber 1 further comprises a product blocker 38 (FIGS. 6 and 8 to 13), which immobilizes the product 4a during its perforation by the sensor 18. When the sensor is centered on the provided sticking point 23, the blocker leans on the product 4a all around the sticking point in order to stabilize the product during the perforation. The blocker can then be slightly moved away from the product during the refrigeration process. During the extraction of the sensor, the blocker, even if slightly moved away from the control product, prevents the control product from adhering to the sensor during the extraction movement of the sensor.

In the example shown in FIGS. 10 to 13, the blocker 38 is secured laterally to the sensor 18 so as to follow the horizontal movements of the sensor. For the axial movements, the blocker 38 has freedom of axial displacement with respect to the sensor 18 by deformation of a compression spring 39. At rest, the blocker 38 is in a protruding position towards the product 4a, abutting against a shoulder 41 secured to the sensor. The tip 19 of the sensor is then backward compared to the active end of the blocker (FIG. 10). Thus, when the sensor is moved axially towards the product 4a, the blocker is the first to come into contact with the product 4a (FIG. 11). The axial movement of the sensor continuing, the blocker can no longer follow this movement and the spring 39 is compressed more and more as the tip 19 gets close to the product 4a (FIG. 12), and then perforates the product 4a (FIG. 13).

FIG. 11 shows another preferred feature of the device, namely a perforating tool 56, which pierces the outer wall of the control product 4a at the intended sticking point, before the perforation by the sensor 16. In this embodiment, the tool is a ring-shaped knife. In this embodiment, the tool is secured to the blocker.

In the embodiment shown in FIG. 14, the image sensor of the preparatory unit 27 captures a top view 2D image of the crate 3a and its content. The image analyzer detects an angle of the crate and the outline of the products that are on top, recognizable by their completely or almost completely visible outline. The top product that is the closest to the axis 22a is selected as the control product 4a. The intended sticking point 23 is in the center of the outline of the product 4a. In the chamber, everything happens as in the first embodiment, except that the vertical distance between the tip 19 of the sensor in the standby position and the intended sticking point 23 can only be assumed and the depth of penetration of the sensor into the product is therefore less precise.

The embodiment of FIG. 15 is further simplified since it does not need a preparatory unit. The identification consists in placing a beacon 41 around a selected product 4a chosen for its situation on the top and near the center of the crate 3a that will be located just below the sticking unit in the chamber 1. In the chamber 1, either an image sensor locates the beacon 41 and pushes the sensor axially at a predetermined position relative to the beacon, for example at the center of the beacon 41, here made ring-shaped, either the beacon 41 is upwardly flared in the shape of a centering cone, as shown. In this second case, the blocker can mechanically self-center in the beacon, the sensor being simply activated vertically with lateral freedom to follow the self-centering movement of the blocker.

In the example shown in FIG. 16, the cutting tool 56a is a sort of slanted rotary drill bit, which can be moved forward until the intended sticking point before the sticking movement of the sensor, and even before the contact of the blocker if one is provided. In a version shown to the right of FIG. 16, the drill bit 56b could be secured to the blocker and take action when the blocker is pressed against the product and before the sticking movement of the sensor.

In the embodiment of FIG. 17, the drilling tool 56c is a tube coaxial with the sensor. The activator first controls the joint movement of the group constituted by the sensor 18 and the tool 56c while the tool is protruding relatively to the tip 19 of the sensor as shown, and then an additional actuator 17a of the activator 17 makes the sensor move forward relatively to the tool so that the sensor penetrates into the control product 4a without being followed by the tool 56c.

Of course, the invention is not limited to the examples described and shown. It would be possible to detect, by 2D or 3D shooting, inside the chamber 1, the selected product and the sticking point, without any preparatory unit (losing the advantage of identification in hidden time and exposing oneself to risks of disruption due to severe conditions inside the chamber).

1.-47. (canceled)

48. A method for automatically controlling at least one parameter at the center of a control product (4a) that is part of a batch (9a, 9b) during a pre-refrigeration or refrigeration process of the batch in a chamber (1) wherein a sensor (18) is stuck into the control product, wherein, in order to stick the sensor, while the batch (9b) is already inside the chamber (1), an activator (17) which carries and moves the sensor (18) inside the chamber (1) is activated, and after the pre-refrigeration or refrigeration process, the activator takes the sensor out of the control product, and a product of the batch is selected as a control product (4a) in such a way that in the chamber (1) the control product is as close as possible to a standby position of the sensor (18).

49. The method of claim 48, wherein the control product (4a) is identified before the entry in the chamber (1), and the identification comprises in associating a beacon (41) to the control product, and there is within the chamber a contact or contactless position detector for detecting the beacon.

50. The method of claim 48, wherein the control product (4a) is identified before the entry in the chamber (1), and the position of a sticking point (23) on the surface of the control product is recorded for the identification, and a signal indicative of the position is sent to a memory, and the content of the memory is used to control the activator.

51. The method of claim 50, wherein the sticking point (23) is a highest point of the control product (4a).

52. The method of claim 48, wherein at least part of the outline of a crate (3a) containing part of the products of the batch is detected and the at least part of the outline of the crate (3a) is used as a reference frame (36), the control product (4a) being selected inside the outline.

53. The method of claim 48, wherein in the chamber (1), during the sticking of the sensor (18) in the control product (4a) and while the sensor (18) is being extracted at the end of the pre-refrigeration or refrigeration process, a blocker (38) is applied on the product, immobilizing the control product (4a) during sticking and extraction.

54. The method of claim 53, wherein, prior to the sticking of the sensor into the control product, an external wall of the control product is pierced at the future sticking point by a tool (56, 56a, 56b) controlled in a coordinated manner with the sensor.

55. A method for pre-refrigeration or refrigeration of a product by a cold-vacuum technique in a chamber (1), wherein the inside of the chamber (1) containing the product is subjected to the combined effects of a vacuum for which the water boils at substantially the desired refrigeration temperature for the product, and a cold temperature produced by a refrigerator (14) which cools the atmosphere inside the chamber, and turns into ice water vapor resulting from the boiling, wherein using a method according to claim 1 a parameter at the center of a control product (4a) being part of the product is automatically controlled, and according to the value of the parameter at the center of the control product, the pre-refrigeration or refrigeration process is automatically controlled.

56. An automatic device for controlling at least one parameter at the center of a control product (4a) that is part of a batch (9a, 9b) during a pre-refrigeration or refrigeration process of the batch in a chamber (1) comprising a sensor (18) to be stuck in the control product (4a) so that a sensitive end (19) of the sensor (18) is at the center of the product, further comprising a product identification unit of the of a product (4a) of the batch, selected as the control product intended to receive the sensor (18), and an activator (17) located in the chamber (1) controlled by an automaton and carrying the sensor in a moveable manner according to the identification firstly by an at least partially lateral centering movement (21) of the sensor (18) on a sticking point (23), and then by a sticking movement (24) of the sensor (18) in the control product (4a) at a beginning of a pre-refrigeration or refrigeration process and an extraction movement out of the control product at an end of the process.

57. The device of claim 56, wherein the sensor is a temperature sensor.

58. The device of claim 56, wherein the identification unit (27) comprises an image sensor and an image analyzer, the identification unit (27) being placed at a station through which the batch (9a) passes upstream of the chamber (1), and able to detect a product as the control product, and to produce a signal indicative of coordinates of the sticking point (23) on the surface of the control product (4a).

59. The device of claim 56, further comprising a detector comprising a feeler designed to self-position on a beacon (41) associated with the control product (4a), and the sensor is coupled to the feeler to laterally move with the feeler.

60. The device of claim 56 further comprising a blocker (41) for immobilizing the control product (4a) during the sticking and during an extraction of the sensor (18) by the activator (17) following the pre-refrigeration or refrigeration process, wherein the blocker (41) is connected to the sensor (18) with an axial sliding freedom beyond a stress threshold corresponding to an immobilization stress applied to the control product (4a).

61. The device of claim 56, further comprising a cleaning device (57) for periodically cleaning the sensor between two batches.

62. The device of claim 56, wherein the sensor is a hygrometry sensor.
